(19) United States
(12) Patent Application Publication
(10) Pub. No.: US 2022/0198477 A1
(43) Pub. Date: Jun. 23, 2022

(54) PROCESS FOR PERSONALITY-BASED CLIENT ALLOCATION AND SELLING ACTIVITY PRIORITIZATION

(71) Applicant: Joel Mier, Richmond, VA (US)

(72) Inventor: Joel Mier, Richmond, VA (US)

(21) Appl. No.: 17/551,700

(22) Filed: Dec. 15, 2021

Related U.S. Application Data
(60) Provisional application No. 63/126,641, filed on Dec. 17, 2020.

(51) Int. Cl. G06Q 30/02

(52) U.S. Cl. CPC G06Q 30/0201; G06Q 30/0204

(57) ABSTRACT

The present invention is directed to the moderating effects of business-to-business (B2B) buyer personal characteristics on the relationship between sales activities and sales effectiveness. Artificial intelligence based personal personality prediction and optionally also geodemographic segments of buyers—as a proxy for personal characteristics—moderate the strength of the relationship between selling activities and sales effectiveness. Overall, the results of use of the present invention demonstrate that selling activities have varying impacts on sales effectiveness within purchaser individual personality and geodemographic segments and buyclass scenarios. While it has been long held that understanding the personal characteristics of the B2B purchasing decision-maker is critical for sales effectiveness, little guidance has been provided on how to accomplish this to scale. The present invention provides a framework and process for practitioner operationalization. The present invention proves that personal characteristics of the purchase decision-maker may transcend business-to-consumer and B2B purchasing contexts.

### PRIORITIZATION

This application claims the benefit of filing of U.S. Provisional Application No. 63/126,641 filed on Dec. 17, 2020, which is incorporated by reference herein in its entirety.

The present invention is directed to a process for using business-to-business buyer characteristics, as reinforced by artificial intelligence predictions of an individual buyer personality, to improve the effect and relationship between sales activities and sales effectiveness.

### BACKGROUND

As multichannel strategies and digitization continue to change the landscape of business-to-business (B2B) markets, including increasing the complexity of personal selling, the productivity of salespeople has remained an important challenge. In recent years, the percentage of salespersons making quota has decreased from 63 to 53 per cent. On the other hand, reports also show that the majority of top sales performers are spending more time using sales technology such as Customer Relationship Management (CRM), citing sales technology as critical to their success for closing more deals. In light of this context, researchers underscore the critical need for both academics and practitioners to uncover factors that could enhance salesperson productivity. Further, in prioritizing top directions for future research that addresses technological changes in selling, scholars stress that the human element of sales continues to be critically important in selling, and that applying new lenses to established research streams can generate novel theoretical and practical applications.

Pervasive in the research streams and models that have created the canon of sales effectiveness is the belief in the importance of buying center members' individual “personality”. The contingency model—which emphasizes the importance of tailoring sales approaches to specific sales situations—posits that sales effectiveness can best be understood by investigating the interactions among sales behaviors; resources of the salesperson; the nature of the customer's buying task; and characteristics of the salesperson and customer. Although previous research has demonstrated a link between B2B purchaser characteristics such as age and how buyers make decisions, testing how purchaser characteristics influence sales effectiveness has remained challenging in a buying center context, perhaps because of limitations of acquiring buying center member-level personal data. To state the obvious, individuals do not wear nametags asserting their psychological makeup.

### SUMMARY

Accordingly, it is an object of the present invention to use in one example geodemographic information, as enhanced by artificial intelligence predicted individual personality data, with respect to a buyer in order to improve sales activity and sales effectiveness.

By understanding the buying center's characteristics with the use of artificial intelligence to assess personality within a taxonomic framework that distinguishes between buyclasses, a sales professional can more effectively address the customer's needs and increase the likelihood of a sale. If buyer personality segments differ depending on the type of buyclass, marketing and sales practitioners can leverage the predicted individual personality as a strategy on how to adapt and allocate assets to both existing clients and prospects.

Engaged scholarship results from a collaborative form of inquiry in which academics and practitioners leverage their perspectives to provide insights to a challenging and complex business problem—it represents a means to bridge the gap between theory and practice. To empirically test these research questions in an application of engaged scholarship, the present invention examines data in a B2B small firm context and using only geodemographic data. There are important reasons that warrant this context. First, in the USA, 98.2 per cent of all firms have payrolls of fewer than 100 employees, whereas in Europe, firms with fewer than 50 employees account for 99.8 per cent of all businesses. Second, while a sizeable portion of US businesses are small and make purchase decisions based on the judgment of a single individual, little information exists about buyer—seller relationships within small businesses. An early test uses only geodemographic data examines a novel dataset compiled from a Fortune 500 financial services company—the dataset containing sales activities and resulting sales for a nationwide salesforce and the 3,178 financial advisors whom they targeted. The dataset also included geodemographic and demographic data for each sales person and targeted financial advisor.

First, the process described herein builds on previous research in sales effectiveness and organizational purchasing by offering empirical evidence that personality is a key factor in B2B selling effectiveness. Second, the process extends the contingency model by applying a new lens—rtificial intelligence predicted personality of a buyer—that identifies new factors that moderate B2B sales effectiveness within the sales dyad. Third, elements of the individual purchase decision-maker, captured through artificial intelligence predictions, may transcend business-to-consumer (B2C) and B2B purchasing contexts, which contributes to the growing discussion of questioning the usefulness of separate B2B and B2C classifications. Finally, the process provides unique insights related to the selling environment represented by buyclass.

The process herein makes several managerial contributions. First, the use of artificial intelligence to predict buyer personality and then use that predicted personality to enhance sales efforts is unique. Second, the choice of analytic framework for this process—subgroup analysis and hierarchical regression—allows for deeper insights at the segment level, enabling sales management to move beyond aggregate analysis and understand which specific activities impact sales effectiveness for each personality segment and buyclass. Third, the process documents a scalable process for enabling sales teams to consider B2B purchase decision-makers' personality in their processes for prioritization. In light of this challenge to continuously update the contingency model, the process described herein applies a new lens—artificial intelligence predicted personality—to the contingency model. Geodemographics can be helpful and is an optional supplement to the artificial intelligence analysis. Specifically, the purpose of the process determines how predicted personality, representing an individual's psychographic and lifestyle profile, influences the relationship between sales activities and sales effectiveness in a B2B setting. Taken a step further, the process explores the moderating impact of the purchaser's buyclass category on the relationship between sales activities and sales effectiveness.

Artificial intelligence can be effective in accurately providing a predicted personality of an individual buyer. (It may also be effective in identifying personality characteristics of a business' own sales people and support structure.) Of course, a business may also directly evaluate its salesforce and representatives. This personality prediction of the buyers facilitates the identification of effective sales people and their specific sales strategies for use with given buyers. Fortunately, an artificial intelligence personality prediction is available from third party vendors including, but not limited to, Crystal and xiQ. This way, the buyer is not burdened with a direct analysis of his or her buyers' personality. Use of the AI-predicted personalities also creates consistency and removes ambiguities from buyers needing to take tests directly themselves. This AI-predicted personality may be deployed alone in the present process or it may be layered in the process with geodemographic information.

Geodemographics can be a powerful and productive supplemental tool. Geodemographics combines elements of geographic, demographic and psychographic approaches. It is based on the concept of social clustering, that people tend to live near people like themselves and that by knowing where someone lives, it is possible to say something about their personal characteristics. Geodemographic segments contain information, including psychographic profiles about households and individuals for virtually every household or individual in most industrialized countries. Because the influence of salesperson activities on sales effectiveness differs across various geodemographic groups, considering geodemographics is used in the present process as a strategy to adapt to the situational context of buyers.

In one example, a method for improving business to business sales through the use of artificial intelligence comprises the steps of identifying an individual buyer for a customer business or prospective customer business; collecting individual buyer information, wherein the individual buyer information comprises the individual buyer's name, address, historical sales and sales results; collecting artificial intelligence-predicted personality information about the individual buyer; comparing sales activities' impacts on sales results by artificial intelligence-predicted personality data. Next, the method includes providing a selling business sales team comprising a plurality of sales team members with the artificial intelligence-predicted personality data from the above step, and developing a sales strategy responsive to that data; developing and implementing a small-scale experiment to test the responsive sales strategy; once tested, then automating and scaling the sales strategy response in a selling company's internal information system and pursuing the sales strategy response across the entire selling business sales team. And finally, tracking the selling business sales team performance and comparing with the artificial intelligence-predicted personality data to confirm the effectiveness of the responsive sales strategy. The method may include wherein the comparing sales activities' impacts on sales results by artificial intelligence-predicted personality data step comprises a hierarchical regression analysis. The method may include wherein the collecting artificial intelligence-predicted personality information about the individual buyer step also comprises collecting buyer-related geodemographic information for use in the following process steps. The method may include further comprising the step of determining the impact on sales results for each sale/marketing activity for each personality category.

In another example, a method for measuring business to business sales performance through the use of artificial intelligence comprises the steps of identifying an individual buyer for a customer business or prospective customer business; collecting individual buyer information, wherein the individual buyer information comprises the individual buyer's name, address, historical sales and sales results; collecting artificial intelligence-predicted personality information about the individual buyer; comparing sales activities' impacts on sales results by artificial intelligence-predicted personality data; and measuring the sales performance of each sales representative for each personality category by analysis of the foregoing sales results.

### BRIEF DESCRIPTION OF THE DRAWINGS

FIG. 1 is a high-level flowchart setting for the process described herein.

FIG. 2 is a more detailed flowchart demonstration the process described herein.

FIG. 3 is a more detailed illustration of the Data Extraction step of the process described herein.

FIG. 4 is a more detailed illustration of the Data Append step of the process described herein.

FIG. 5 is a more detailed illustration of the Data Combining step of the process described herein.

FIG. 6 is a more detailed illustration of the Data Analysis phase of the process described herein.

### DETAILED DESCRIPTION

The process disclosed herein has two very-high level phases. There is first the Data Preparation phase, and then next the Data Analysis phase. Both are discussed herein generally and then in a very detailed example. It is in the Data Preparation phase that artificial intelligence (AI) is used to predict the personality of a business' buyer or prospective buyer. The personality may be assessed in different types, each of which could be useful, including, but not limited to, DiSC, Myers-Briggs, Big Five, and 16 Personality. In the given example, The DiSC framework is found to be very informative and useful in buyer personality predictions.

The key to this process is the identification and usage of data that reflects individual personality or consumer segment membership. A general method to capture and utilize this information is the use of geodemographics. Geodemographics is based on the concept of “homophily,” that people who live near you are more like you as compared to people who do not live year you. Commercial companies such as Nielsen, Experian, and Acxiom have created geodemographc profiling systems that utilize census data and non-publicly available consumer behavioral data. Their systems have categorized nearly each US household and adult within one of their respective consumer segments and this data is available for commercial purchase. This geodemographic data is useful only too a point, because the data is a general estimation based solely on group-derived information.

A better alternative is based on the significant gains in Artificial Intelligence (AI), Machine Learning (ML), and Natural Language Processing (NLP). For the purposes of the present disclosure, the terms “artificial intelligence includes all of the foregoing AI, ML and NLP, and other individual, digitally-based information. While there are many individual personality categorization schemes, usage of these systems has required the individual to participate in the assessment by answering questions and having a scoring algorithm applied. Recently, companies have emerged that are able to predict an individual's personality by using publicly available internet web information. By applying AI to individuals' individual web information including social media posts and commentary, resumes, news articles, email text and other public web data, individual personality predictions can be made for most every person. This individual AI-derived personality information may or may not include geography as one source of individual information. However, it is the AI-derived information produces more accurate individual information that just geography generalizations alone. This data is more accurate and personality detailed that allows for better individual sales contact preparation. Of course, the present process does not discount the experiences of individual buyer-seller relationships that may develop over time. But even in existing relationships, additional buyer data may facilitate even better sales performance.

The first step in in the process herein, in the Data Preparation phase, is data extraction. This means extracting historical data from a subject business/organizations CRM/database. The extraction includes generally pulling all sales and marketing activities of the business/organization for a meaningful time period, in one example at least about the prior 12-18 months. In a traditional business model, each customer/lead/prospect (C/LIP) has an assignment to a specific sales representative, so the data is representative of the relationship between sales rep and customer/lead/prospect. The extraction includes available specific actions taken by the sales rep towards the other individual in the dyad. The data is extracted in available periods, in one example it is extracted monthly. Alternatively, if available, it may be extracted daily or weekly or quarterly or transactionally or other asymmetric time periods. Also extracted are the sales units for the same time periods. The data will also include organizational variables about a C/L/P, for instance, company size, channel category, size, strategic focus level of sales firm, etc. The name and address of each sales rep as well as each customer/lead/prospect is collected. Additionally, any correspondence and other digital information, including public web information, is also collected.

In the second step, the data is processed and additional third-party input may be provided. The goal is to enhance each record (relationship between sales rep and C/L/P) with personality data for each part of the dyad. If geodemographics are considered, the name and address and employer of sales rep and C/L/P are sent to third parties to have personality data identified and appended. These third parties include, but are not limited to, Experian, Nielsen, and Acxiom. Regardless of whether geodemographics are considered, AI- predicted personality data, for instance in a DiSC framework, is obtained from third party providers including, but not limited to, Crystal and xiQ.

And finally in the data preparation phase, the data is combined so that the extracted sales and marketing data in step 1 is combined with the appended data from the external provider(s) to create a single file where, in one example, each row represents a relationship between a sales rep and a C/L/P and includes all information about the sales rep and C/L/P (personality), the specific periodic (e.g., monthly) activities (volumes) taken by the sales rep and the firm, organizational variables about the C/L/R's organization, and the monthly sales generated.

Once collected and prepared in phase one, the data is then specifically analyzed for use by the business/organization. This analysis phase typically has two areas for analysis. The data may be used to measure a sales individual or department performance. Additionally, the data may be used to assess and guide sales activities going forward.

In the analysis of an individual salesman or department, the data may reveal the performance for each sales rep for each personality category by analyzing historical sales results. In this analysis, it is important to control for relevant categorical variables like experience, tenure, firm size, duration of relationship, and more (differs by vertical). The result is that it is possible to calculate averages for each sales rep by each personality type by taking into account control variables.

In the analyses to find prospective future activities, using analytics software programs, it is possible to run hierarchical regression of multiple categories of variables including independent variables: each sales and marketing activity; control variables: experience, tenure, firm size, duration of relationship; and dependent variable- sales. While a hierarchical regression is noted herein, other statistical models may be used to test and analyze the all of the collected data. The run regression is made for the total sample first. Then, the regression is run for subsets of each personality type (subgroup) with sample >n=100. For each of these “runs”, the analysis looks at two key output variables from the software—R2—model quality (higher is better), and beta coefficients for each independent variable to determine direction (+/−) and strength of each variable on sales. The result is that it is possible to determine the positive, negative, or neutral impact on sales results for each sales/marketing activity for each personality category.

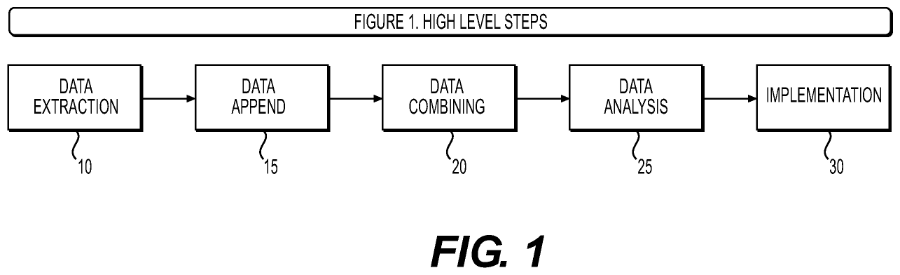

FIG. 1 is a high-level flowchart view of the foregoing two-phase process. The first general step is the data extraction step 10 as described earlier. Once the information is collected, the next step is the data append step 15. As noted earlier, this step 15 includes harvesting AI-based data regarding the individual personality of the target buyer individual. The next step is the data combining step 20 that integrates both the raw information about the dyad in combination with the AI-based personality information. At this point, the combined data is then analyzed, step 25, and ultimately implemented in step 30.

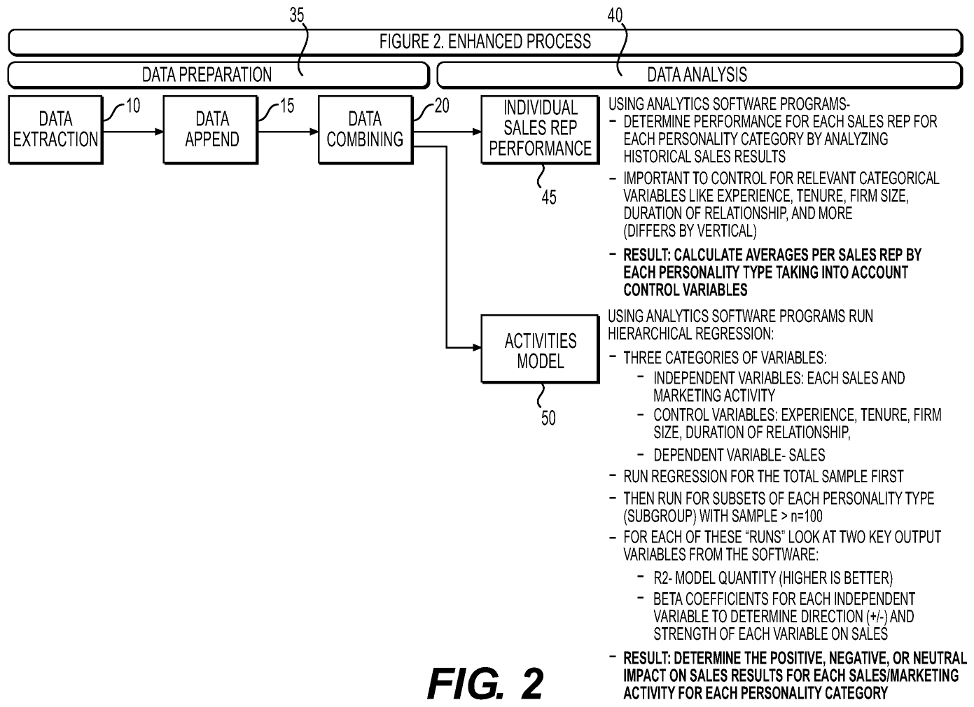

FIGS. 2-6 illustrate the actions in each of the main flowchart steps in FIG. 1. FIG. 2 illustrates the data extraction 10, append 15, and combining 20 steps all under the the first phase Data Preparation phase 35. The individual sales rep performance 45 and activities model 50 steps are shown under the Data Analysis phase 40. Examples of the analysis steps 45 and 50 also show some specific explanation of examples of those steps.

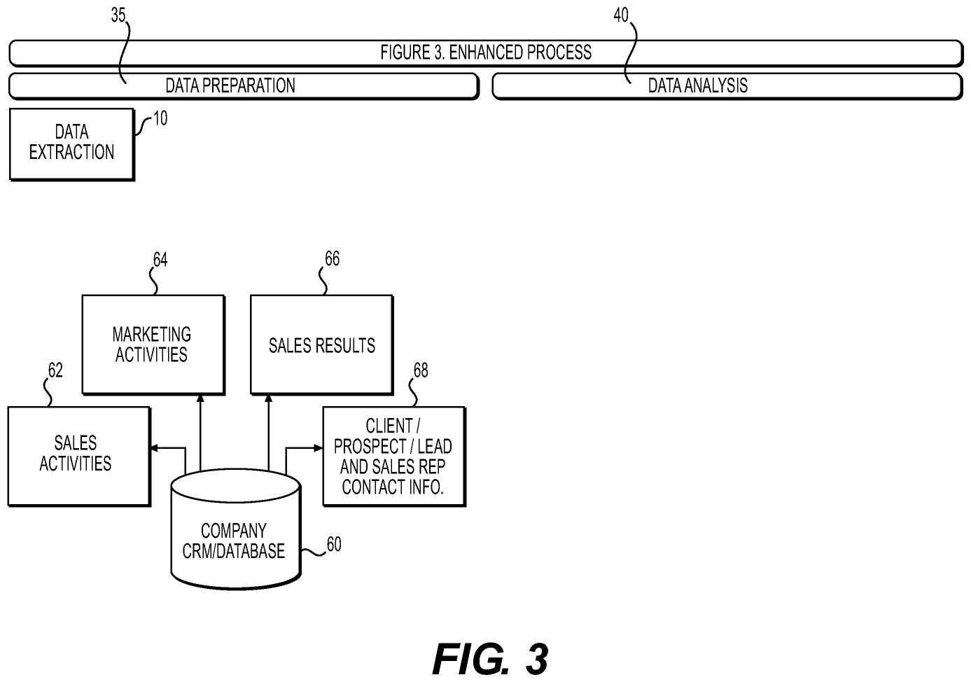

FIG. 3 expands on the example specifics of the data extraction step 10. As shown, the seller company CRM/database 60 may collect its own information including sales activities 62, marketing activities 64, sales results 66 and client/prospect/lead and sales rep contact information to begin the data preparation phase 35 of the process herein.

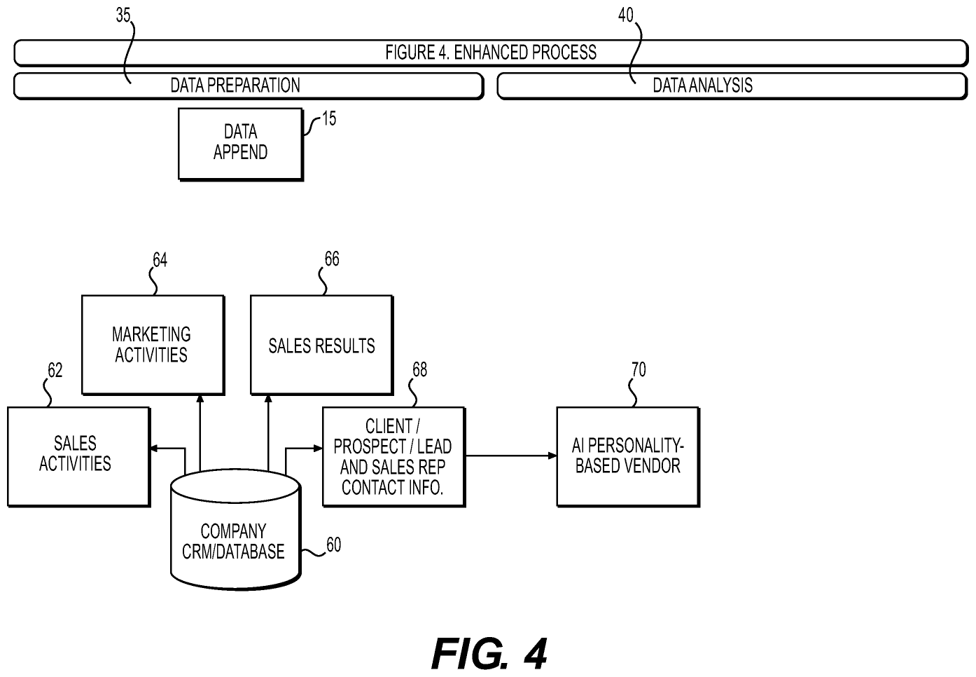

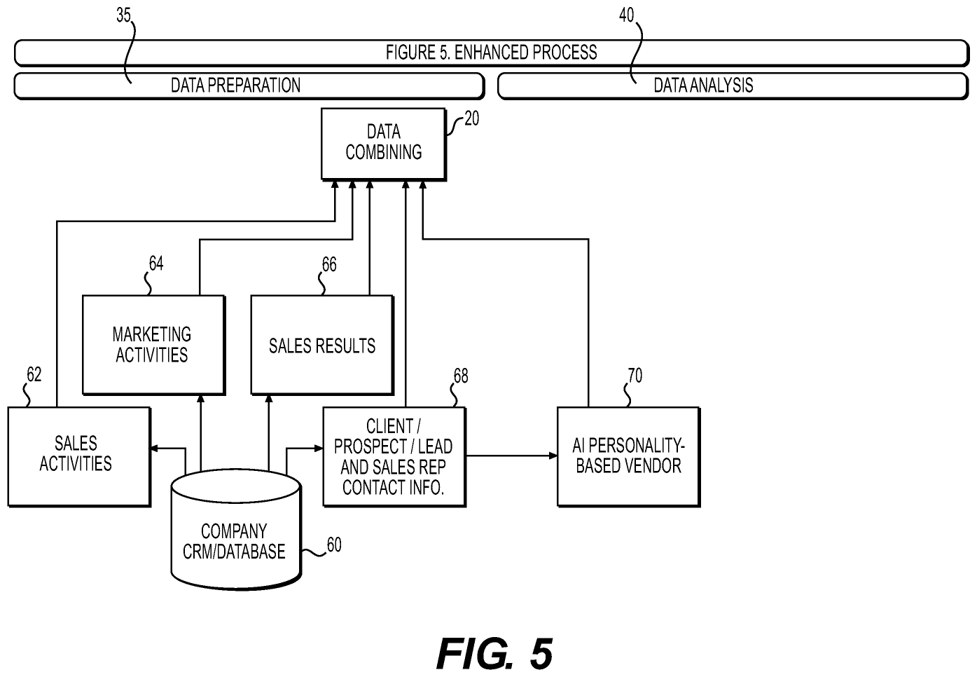

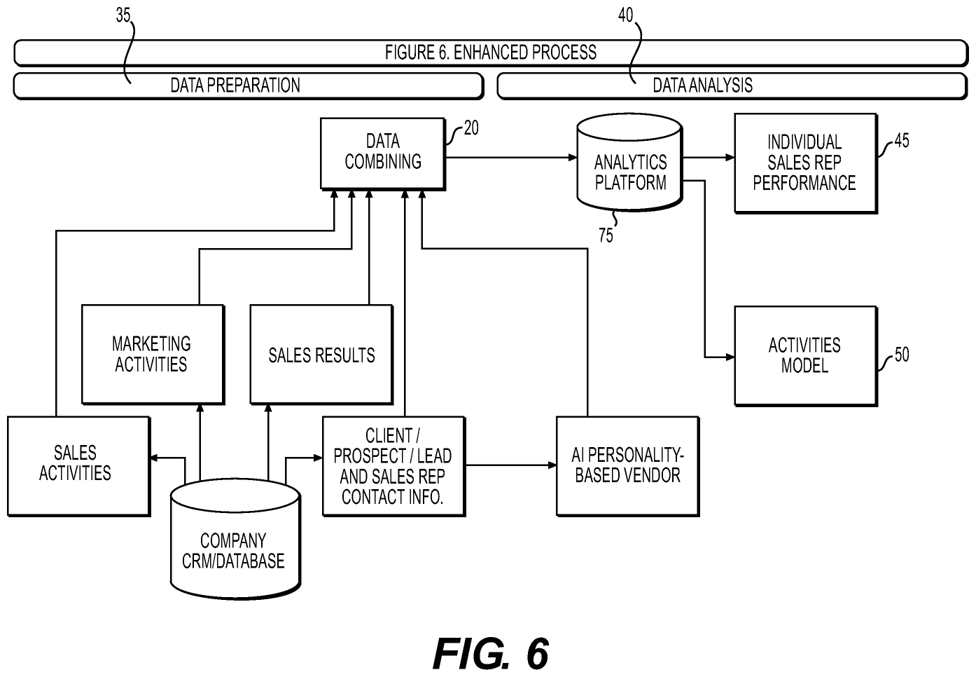

FIG. 4 expands and shows an example of the data append step 15. As shown, the information that may be collected from the seller's company CRM/database then leads to the data append step 70 of using an AI personality-based vendor to enrich the company data. In FIG. 5, the information from the seller company CRM/database 60 is combined with the AI individual personality information 70 in the data combining step 20 of the data preparation phase 35. And finally, FIG. 6 illustrates the use of the combining data step 20 incorporated into a data analytics platform 75 in the data analysis phase 40. The analytics platform 75 feeds into and directs the individual sales rep performance 45 and activities model 50.

As explained earlier, the geodemographic information about C/L/P is not as accurate and does not allow for predictive behavior as well as individual personality data derived from AI processes. The individual metrics are an improvement over general geography-based metrics. Nevertheless, a geodemographic-based example does provide an early peek at the value of buyer information may be used.

### EXAMPLE

A detailed example of the process embodying geodemographic information only will now be explained. As noted, the process will be similar to one of the present invention that uses individual personality-based information developed by AI analyses instead of or in addition to geodemographic information. This one example is shown in the financial services industry. The present process may also be employed in other industries including for instance and not by limitation, the pharmaceutical, industrial manufacturing, and agricultural industries. The process described above may be used effectively in many cases.

The example study's focus is within the U.S. life insurance industry because of two primary conditions. First, sales professionals in this field rely heavily on prospect qualification for identifying potential clients. Second, the published evidence indicates wide differences in selling performance across sales professionals. Within this context, the example objectives were addressed with the cooperation of a leading U.S.-based life insurance company.

Data from a divisional salesforce 0116 “external” sales professionals with regional responsibility that covered the entire U.S. was used in the study. This team is known in industry parlance as “external wholesalers” (EW) and has face-to-face contact with financial advisors. In addition, the firm supplied data for a team of supporting internal sales professionals (“internal wholesalers” or IW). These sales teams focused exclusively on one insurance product category. The participating firm sells almost exclusively through independent distribution and shared a full year's sales activity history and sales results for 3,178 financial professionals who were associated with two similar nationwide financial advisory firms. Resultantly, the participating firm's salesforce's efforts are aimed not at consumers, the ultimate purchaser of the insurance solutions, but at financial professionals.

These targeted financial professionals are in essence “intermediaries.” It has been argued that insurance products are inherently complex which make it difficult for consumers to understand the coverage they need and to adequately review the policy features, services, and claims-paying capabilities of insurers. The role of the financial professional is to scan the market, match clients with insurers who have the skill, capacity, risk appetite, and financial strength to underwrite the risk, and then help the client select from competing offers.

Sales activity data was provided for 63 separate categories within the firm's taxonomy. In addition to the sales activities and results for relationships between the 16 EWs, 10 IWs, and the 3,178 targeted financial professionals, the participating company had additional data elements appended at the level of individual financial professional, including demographic and geodemographic segment, by a commercial data provider. A 100% match rate was attained for all records. Another integrated data element was provided by the firm's distribution partners that employ the 3,178 financial professionals: the size of each financial professional's practice. This was provided for 85.3% of the sample, yielding a final sample size of 2,710.

While the dyadic data supplied by the participating life insurance company was monthly in structure, it was decided to aggregate all sales activities and sales effectiveness measures into annual measures. The company's view of the length of the sales process is consistent with B2B sales cycle findings.

### Independent and Dependent Variables

Selling activities. The participating life insurance company provided a monthly record of the salesforce's activities from January 2014 to December 2014. The firm had its own taxonomy of 21 and 42 separate categories for its EWs and IWs, respectively. Examples of sales activities include a phone call or email, a client workshop, a single or group financial advisor (FA) meeting, or fulfilling a request for product literature. These activities were entered into the firm's Customer Relationship Management (CRM) system by the sales teams. An evaluation of these 63 categories identified that only 23 (nine for EWs and 14 for IWs) were appropriate for analytical purposes. The data collected for each of these sales activities refers to the number of times each was utilized. As the participating life insurance company sought to directly utilize the findings from the study, its taxonomy was utilized instead of introducing one following extant research.

Sales effectiveness. Consistent with research conducted in the life insurance industry, sales effectiveness is measured by the number of policies submitted by financial professionals within each salesperson's territory for the calendar year 2014. Financial professionals averaged 1.12 submitted applications during the time period studied. Applications were submitted by 35.6% of the financial professionals in 2014 and 71.3% sold the participating firm's insurance solutions in the 24 months prior to 2014.

Buyclass category. The financial professionals had one of two statuses: they had either submitted a policy to the insurance carrier within the category prior to 2014 or they had not. Applying descriptions of new buy, modified rebuy, and straight rebuy, any application submission from a financial professional who had never submitted one prior is considered a “newbuy” while all other submissions, stemming from those who had submitted prior applications, will constitute a combined “rebuy”. This is supported by research that suggests that most predictions generated by the buyclass framework are based on the distinction between two categories—new buy and straight/modified rebuy.

Geodemographic segmenta The firm appended geodemographic segment variables from a leading international data and analytics firm with 100% match rate attained. The geodemographic system employed clusters of U.S. households into one of 21 life stages and serves as the measurement for individual personal characteristics in this study. For a listing and brief description of the six segments represented and analyzed in the final dataset, see Table 1.

TABLE 1
Geodemographic Segment Descriptions

| Segment ID | Segment Description |
|---|---|
| Segment 1 | Income is high; 80% of the segment at $100,000 or more. Big money is made, traded or |
| “Coastal | banked. Members have high education levels and professional occupations, with many |
| Affluents” | concentrated on or near the East and West Coast. Primarily comprised of married |
| | couples with children under 18, with some having grown children. Members focus on |
| | the future, with college savings plans and life insurance valued at $500,000+. |
| Segment 2 | Mostly between ages 46-65, the members share affluence and spending habits. Buying |
| “Midlife | and doing most everything their money can afford, these cohorts tend to be |
| Mavens” | concentrated in costly markets in New England, the Mid-Atlantic and Pacific. Half of the |
| | segment's members are in the top income category, earning $150,000+. Three-quarters |
| | are married, and virtually all children are 18+. |
| Segment 3 | This segment is one of the more affluent, with high household incomes and home |
| “Single & | values, as well as having a higher percentage of households with college educations. |
| Loving it” | Childless and relatively mobile, this segment seems committed to enjoying the good |
| | life. They are more likely to be single, none have children and all have an income of |
| | $50,000+. |
| Segment 4 | Parents of older, school-aged children, the members are well educated with upper- |
| “Suburban | middle incomes and net worth. Typically, owners of homes in the metro fringes and |
| Parents” | suburbs, these households are commonly absorbed in the lifestyles dictated by |
| | traditional parental roles. Many are 50-year old homeowners with children 18 and |
| | under; approximately half are married; more than 90% have income from $50,000- |
| | $99,000. |
| Segment 5 | This group is approaching retirement on solid financial footing and enjoying the perks |
| “Prepared | of financial security. Well off enough to enjoy the option of early retirement, many of |
| Pre-Retirees” | the members of this segment continue to work, often in upscale, white-collar |
| | occupations. Sharing high rankings for both education and net worth, the members |
| | often exhibit similar investment and spending patterns as well, such as for real estate, |
| | luxury cars and foreign travel. |
| Segment 6 | All members have children at home - many under the age 18 - with middle to upper |
| “MidAmerica | income levels and net worth. Nearly all are married and most own their own home, with |
| Families” | home values spanning all ranges. Many live in the Midwest and one-third of segment |
| | members live in a household that includes five or more members. These families make |
| | significant expenditures on their children. |

Control variables. Through evaluation of prior research on sales effectiveness moderation and discussions with the firm's leadership, the following variables were included as control variables: Firm—identifies which of the two financial advisory firms employed the individual financial professional; Practice size—a categorical classification with five levels created by the participating life insurance company from data provided by its two distribution partners regarding the relative size of each financial professional's practice (assets, client base size, and growth rate); Number of solution categories sold—identifies how many of the four categories of life insurance commercialized by the participating life insurance company had been sold by the individual financial professional prior to Jan. 1, 2014; Sales experience—this variable is indexed as the average of the individual external wholesaler's years in financial products and services sales, years with the participating life insurance company, and years supporting the individual financial professional. A composite measure was formed by averaging z-scores of the three indices.

Analysis Procedure

Moderator analysis. The concept of moderation is essential to testing contingency theories and has enabled meaningful developments in various organizational themes including sales effectiveness, individual and organizational sales performance, and customer trust. Moderating effects can be examined in two primary ways: by including interaction variables in an additive model or by estimating parameters of an additive model for subgroups of a total sample. Analysis using interaction terms examines the form of a relationship while subgroup analysis examines the strength of a relationship. In order to test for different strengths of relationships, differences of correlation coefficients for the different values of the moderator must be evaluated. It is assumed that a variable is a moderator if significant differences in the regression coefficients occur within the subgroups. Subgroup analysis is appropriate to test for moderation when the moderator variable is categorical. Because the goal of this study is to assess the strength of relationship of two categorical moderators on the relationship between sales activities and sales effectiveness, the process employed subgroup analysis.

Hierarchical regression. To evaluate differences in the regression coefficients within the subgroups, the preferred method of hierarchical regression was applied. Hierarchical regression analysis enabled the determination of the relative impact of sales activities on sales effectiveness after controlling for market structure. Consistent with prior research, regression analyses were first conducted for all observations in the dataset (restricted run). Regression analyses for each subgroup were then performed, allowing the regression coefficient estimates to take on different values across each subgroup (unrestricted run). An “all other” category for segments with small membership counts was also evaluated for the purposes of statistical testing but are not addressed here due to its aggregated nature. The four control variables were entered in the first step of the hierarchical regressions followed by the 23 independent variables (“IV”) in the second step. The Chow-test was then applied using the differences in the sums of squared residuals from the restricted and unrestricted regression runs. The statistical significance of the difference in the regression coefficients in sales effectiveness across the different subgroups were then examined.

Two checks for multicollinearity of the IVs were performed. First, the intercoaelations among the IVs were examined and while several of the correlations were found to be significant, none of the variables were highly correlated with the others. The highest correlations between the 23 IVs were found between Proactive and Proactive Email (r=0.58), followed by Illustration (r=0.31) and Proactive (r=0.31). Second, none of the variance inflation factor statistics exceeded 1.89, the level in which multicollinearity may pose a problem. As a result, it was concluded that multicollinearity was not a concern.

### Results

There is strong support for the moderating effect of geodemographic segment on the relationship between sales activities and sales effectiveness. Chow test results on the total population yielded statistically significant results (F=16.273, df=28, 2,710, p<0.001) as did Chow tests within both the Rebuy dyads (F=20.182, df=28, 1,918, p<0.001) and Newbuy dyads (F=43.356, df=28, 792, p<0.001). These findings support the generally untested proposition that personal characteristics of the purchasing decision maker in B2B environments may play a meaningful role in the purchase process.

Additionally, there is partial support for the moderating effect of the individual purchase decision maker's buyclass category on the relationship between sales activities and sales effectiveness. While Chow test results on the total population yielded statistically significant results (F=2.43, df=28, 2,710, p<0.001) as well as within two of the six geodemographic segments (see Table 2 below), results were found not to be statistically significant within four of the six individual geodemographic segments. This finding, in part, supports the contention that the customer's buying task should act as a moderating variable and suggests that the implications of the buyclass model for sales effectiveness may be considerable.

TABLE 2

| Moderator | Dependent | Population | Moderator | | Chow |
|---|---|---|---|---|---|
| Variable | Variable | Filter | Subgroup | R² | Test |
| Geodemographic | Sales | | Segment 1 | 0.403 | 16.273*** |
| Segment | Effec- | | Segment 2 | 0.522 | |
| | tiveness | | Segment 3 | 0.569 | |
| | | | Segment 4 | 0.875 | |
| | | | Segment 5 | 0.486 | |
| | | | Segment 6 | 0.451 | |
| | | | Segment 7 | 0.385 | |
| Geodemographic | Sales | Newbuy | Segment 1 | 0.405 | 43.356*** |
| Segment | Effec- | | Segment 2 | 0.736 | |
| | tiveness | | Segment 3 | 0.700 | |
| | | | Segment 4 | 0.707 | |
| | | | Segment 5 | 0.588 | |
| | | | Segment 6 | 0.729 | |
| | | | Segment 7 | 0.225 | |
| Geodemographic | Sales | Rebuy | Segment 1 | 0.422 | 20.182*** |
| Segment | Effec- | | Segment 2 | 0.499 | |
| | tiveness | | Segment 3 | 0.623 | |
| | | | Segment 4 | 0.910 | |
| | | | Segment 5 | 0.575 | |
| | | | Segment 6 | 0.443 | |
| | | | Segment 7 | 0.398 | |
| Buyclass category | Sales | | Newbuy | 0.364 | 2.426*** |
| | Effec- | | Rebuy | 0.401 | |
| | tiveness | | | | |
| Buyclass category | Sales | Segment 1 | Newbuy | 0.405 | 1.666* |
| | Effec- | | Rebuy | 0.422 | |
| | tiveness | Segment 2 | Newbuy | 0.736 | 0.572 |
| | | | Rebuy | 0.499 | |
| | | Segment 3 | Newbuy | 0.700 | 0.686 |
| | | | Rebuy | 0.623 | |
| | | Segment 4 | Newbuy | 0.707 | 1.097 |
| | | | Rebuy | 0.910 | |
| | | Segment 5 | Newbuy | 0.588 | 1.615* |
| | | | Rebuy | 0.575 | |
| | | Segment 6 | Newbuy | 0.729 | 0.929 |
| | | | Rebuy | 0.443 | |

*p < .05
** p < .01
***p < .001

Hierarchical regression analysis. The restricted run of the hierarchical regression identified that of the 23 individual sales activities analyzed, 11 were statistically significant to sales effectiveness (see Table 3 below). Three of the 11 activities were employed by EWs (33.3% of all EW activities) while the remaining eight were utilized by IWs (57.1% of all IW activities).

The most impactful activity an EW could perform is a Center of Influence Meeting (COI_Mtg, β=0.216, p<0.001) whereby he or she meets with both an influential professional from an outside firm or organization and a targeted financial advisor to explore opportunities for access to new potential clients. For example, an EW could arrange an introductory lunch meeting between a targeted financial advisor and a local elder law attorney. The two other EW sales activities significantly related to sales effectiveness are Financial Advisor Meeting (FA_Mtg, β=0.158, p<0.001), an in-person meeting between an EW and a financial professional and Point of Sale (POS, β=0.052, p<0.01) which is a face-to-face discussion with a financial advisor and his or her client to specifically address the client's individual circumstances. All three variables represent in-person interactions between the EWs and financial professionals. This has significant cost implications to the firm as face-to-face interactions may require travel, lodging, and associated costs.

The role of the IW is largely to support an associated EW's sales efforts as well as to react to assigned financial advisors' needs in a timely manner. Many of the participating firm's IW categories are reactive in nature and outside of the IW's control with the exception of response time. There are 14 separate sales activities for IWs, eight of which were identified as statistically related to sales effectiveness. Ten categories of these activities are reactive by definition with six identified as significant.

The two reactive IW activities with the greatest impact on sales effectiveness are Underwriting Follow Up (UW_Follow_Up, β=0.132, p<0.001) and Email (Email, β=0.118, p<0.001). The variable Underwriting Follow Up related to an IW investigating the status of a submitted application within the firm's underwriting department. Depending on the decision by this function, an applicant—a financial advisor's client—may be approved or disapproved and subject to varying premium levels based on health status findings. Financial advisors generally strive to have a client approved at the lowest possible premium rate and when this is not the case it often results in client dissatisfaction with the financial advisor, not the insurer itself. Email entails an IW responding to an incoming financial advisor's email. This is assumed by the firm to be generally reactive in nature due to the existence of a separate proactive categories—Proactive, Proactive Email, and Proactive Voice Mail.

Four categories of1W activities are proactive and are thus completely under the discretion of the IW. Of the four, two were deemed as significantly related to sales effectiveness. The proactive IW communication activity Proactive (Proactive, β=0.332, p<0.001) has the largest impact on sales effectiveness of all variables analyzed. This sales activity involves the IW proactively reaching out to a financial advisor, oftentimes attempting to anticipate needs, strengthen relationships, or share some information of value such as a product launch or competitive positioning information.

Uses of Artificial Intelligence

Data science, including artificial intelligence, machine learning, and natural language processing, (as noted earlier, collectively herein referred to as AI), enable the classification of individuals based on their individual personality traits. Each person can be categorized into a specific personality category amongst one of the many personality systems utilized. This availability of a large volume of multi-dimensional data paves the way for increasing business outcomes. Businesses can now understand, and predict how an individual is likely to respond for given scenarios. Individual personality can be applied to customer services, marketing, sales, and other corporate relationship matters.

Social media platforms such as Facebook, lnstagram, Twitter, Linkedin, and others have become the most widely used destinations for internet users. Social network activities - liking, sharing, posting, commenting, and more—provide an excellent platform for researchers to utilize these platforms and their users to study and understand the relationship between one's online activities and usage with their individual personality preferences. Additionally, historical email interaction can be used by AI to predict personality. Still further, other writings including publications or other public documents written by an individual can be mined with AI to predict personality or at least enrich the individual personality prediction from other sources noted above.

Companies having technology solutions that enable predicted personality data include, but are not limited to, the following: Crystal, iqX, and IBM. These and similar companies are utilizing social media data and public activities to predict individual user personalities. Crystal, for example, identifies that its predictions are reported accurate 97% of the time. Other studies also confirm high rates of accuracy.

These AI-based advances represent significant improvements in accurately categorizing individuals. Geodernographics, a staple in business since the 1970s and as explained above, generally categorizes individuals based on their zip code (zip+4) which equates to approximately 100 households. In other words, all individuals in each 100 household clusters are categorized the same. The technology driven advances in AI is able to move far beyond the 100 household clusters and predict the actual individual based upon the individual's social media profiles and other public or private resources. The result is a far more accurate and representative prediction.

Based on historical sales and marketing activity and sales analysis, and further based on the individual AI personality analysis, businesses are able to define which sales and marketing activities have positive and negative impacts on sales for each individual customer personality type. For example, certain personalities will prefer to meet face-to-face versus other forms of communications. Conversely, other personalities would prefer to communicate via email or text and avoid face-to-face interactions. Another example may be the degree of directness in business communication: some personalities prefer to get directly to the point while others will prefer to have a few moments of personal connection prior to discussing the business task at hand. All of this information is made available to the business team, and as a result individual buyer plans can be implemented.

Discussion

Theoretical Implications

“Personal characteristics” of the B2B purchaser has been identified as a critical element in understanding and optimizing the buyer-seller relationship; however, a lack of data availability has made this an area more of promise than reality. The results of the current study support that geodemographic segments—as a proxy for personal characteristics—moderate the strength of relationship between specific selling activities and sales effectiveness. Overall, the results demonstrate that specific selling activities have varying impacts on sales effectiveness within geodemographic segments and buyclass scenarios, enabling managerial operationalization at the individual sales person and customer or prospect level. The personality characteristics of the purchaser become even more specific and clear with the use of AI-based personality analysis of the individual purchaser.

The choice of analytic framework for this study—subgroup analysis and hierarchical regression—allows for deeper insights at the segment level, enabling sales management to move beyond aggregate analysis and understand which specific activities impact sales effectiveness for each segment and purchase type. Other types of mathematical analyses may be deployed to obtain specific information that might be useful for other applications. Managerial implications

Since commercial geodemographic systems have been created for consumer applications, data exists for virtually every individual or household in most industrialized nations making this source immediately available and scalable for firms with the presence of names and addresses of customers. And while the generalized data of geodemographics may be useful, the use of AI-based individual personality analysis allows even more specific actionable information. This overcomes two significant barriers currently faced by businesses of all sizes: identifiability and accessibility of segments. As such, these systems offer a viable, scalable approach for firms and sales organizations to better understand customers and prospects and subsequently allocate resources accordingly.

The study's results also suggest that companies with external and internal sales functions should fully understand the value that each creates for customers and which specific activities drive sales effectiveness. Consistent with life insurance industry practices, the participating firm allocates far more resources and incentives towards its external sales teams. However, more sales activities undertaken by the firm's internal sales team were found to be significantly related to sales effectiveness.

While the specific results and impact of specific sales activities of this study, based on the environmental context of a single Fortune 500 financial services firm, may not directly apply to other firms' sales efforts, the process described herein outlines a process for managers to utilize in which categorize each customer and prospect by geodemographic segment and individual personality, measure the impact of specific sales activities to each segment and individual, and be able to increase sales effectiveness by altering sales' targets and utilization of specific sales activities:
Step 1—Using a CRM system (if available), extract all relevant customer and prospect info (e.g., name, address, historical sales, sales results) into a spreadsheet.
Step 2—Evaluate leading data providers for AI-based individual personality data, and optionally also geodemographic data. Select one that meets company needs (e.g., timing, budget). Upon sending the company spreadsheet, the data provider will append the individual personality and geodemographic variables.
Step 3—Upon receipt of the company appended file, analysis can commence. Depending on the firm's analytic capabilities, rudimentary analysis in spreadsheets focusing on differences in results by individual personality and optionally geodemographic segments all the way to advanced regression and modeling techniques taking into account control variables in the analysis should be employed. This process will identify differences in specific sales activities' impact on sales results by individual personality and optionally also geodemographic segment and lay the foundation for change.
Step 4—Engage the company sales team in the process and share the results of the analysis. Educate them about the different geodemographic segments and ask them for hypotheses about the analysis. This will expand the company perspective on the opportunity as help with “buy-in” from the sales team.
Step 5—Identify rapid small-scale experiments and tests that the sales team would be comfortable engaging in, such as prioritizing different individual personalities and geodemographic segments within existing customers or prospects. Identifying interested sales colleague is important because those colleagues could become internal advocates amongst the sales team, a critical element in driving adoption. Finally, clear measurements for the experiments need to be established to support organizational buy-in.
Step 6—Automate and scale the knowledge that is established. All customer and prospect segment data needs to be fully integrated within the firm's CRM and be made prominent to the sales teams as they access customer records. In addition, based on the prioritized customer or prospect to be engaged, the CRM should make automatic suggestions on specific actions the sales professional should take given the segment and buyclass of the targeted financial advisor. To inculcate this behavior, sales professionals should be incented to follow the recommended sales activities and managers should receive regular reports to support the effort.
Step 7—In parallel with Step 6, the firm's insights function should construct primary research of customers and prospects to be able to understand issues, attitudes, and preferences by each segment beyond those standard themes captured by the AI personality and geodemographic system provider. This will allow more of the organization to be able to better understand and meet the needs of customers based on specific areas of exploration related to the financial services industry. Questions could revolve around areas such as service, operations, product, sales, brand, communications, product, and even competitive offerings.

Other embodiments of the present invention will be apparent to those skilled in the art from consideration of the specification. It is intended that the specification and figures be considered as exemplary only, with a true scope and spirit of the invention being indicated by the claims.

That which is claimed is:

1. A method for improving business to business sales through the use of artificial intelligence, the method comprising the steps of:
a) identifying an individual buyer for a customer business or prospective customer business;
b) collecting individual buyer information, wherein the individual buyer information comprises the individual buyer's name, address, historical sales and sales results;
c) collecting artificial intelligence-predicted personality information about the individual buyer;
d) comparing sales activities' impacts on sales results by artificial intelligence-predicted personality data;
e) providing a selling business sales team comprising a plurality of sales team members with the artificial intelligence-predicted personality data from step d), and developing a sales strategy responsive to that data;
f) developing and implementing a small-scale experiment to test the responsive sales strategy;
g) once tested as in f), then automating and scaling the sales strategy response in a selling company's internal information system and pursuing the sales strategy response across the entire selling business sales team; and
h) tracking the selling business sales team performance and comparing with the artificial intelligence-predicted personality data to confirm the effectiveness of the responsive sales strategy.

2. A method for improving business to business sales through the use of artificial intelligence as described in claim 1, wherein the comparing sales activities' impacts on sales results by artificial intelligence-predicted personality data step comprises a hierarchical regression analysis.

3. A method for improving business to business sales through the use of artificial intelligence as described in claim 1, wherein the collecting artificial intelligence-predicted personality information about the individual buyer step also comprises collecting buyer-related geodemographic information for use in the following process steps.

4. A method for improving business to business sales through the use of artificial intelligence as described in claim 1, further comprising the step of determining the impact on sales results for each sale/marketing activity for each personality category.

5. A method for measuring business to business sales performance through the use of artificial intelligence, the method comprising the steps of:
a) identifying an individual buyer for a customer business or prospective customer business;
b) collecting individual buyer information, wherein the individual buyer information comprises the individual buyer's name, address, historical sales and sales results;
c) collecting artificial intelligence-predicted personality information about the individual buyer;
d) comparing sales activities' impacts on sales results by artificial intelligence-predicted personality data;
e) measuring the sales performance of each sales representative for each personality category by analysis of the foregoing sales results.
